(19) United States
(12) Patent Application Publication
(10) Pub. No.: US 2025/0074333 A1
(43) Pub. Date: Mar. 6, 2025

(54) Electronic System and Method for Updating Vehicle Color Change Date, in Real Time

(71) Applicant: Select Software and Business Solutions A.E.B.E., Pefki (GR)

(72) Inventor: Ioannis Sideris, Kifisia (GR)

(73) Assignee: Select Software and Business Solutions A.E.B.E., Pefki (GR)

(21) Appl. No.: 18/948,915

(22) Filed: Nov. 15, 2024

Related U.S. Application Data
(63) Continuation of application No. PCT/GR2023/000016, filed on May 2, 2023.

(30) Foreign Application Priority Data
Jul. 7, 2022 (GR) 20220100540

(51) Int. Cl. B60R 13/00; G06F 3/0482; G06F 21/40

(52) U.S. Cl. CPC B60R 13/00; G06F 3/0482; G06F 21/40

(57) ABSTRACT

A method includes establishing a unique pairing between a smart device and a vehicle to transmit to relevant administrative and/or private bodies as well as with further competent authorities an authenticated vehicle color change request. Upon approval, updated registration documentation is provided and only then is the color change authorized to be carried out for the vehicle.

### CROSS-REFERENCE TO RELATED APPLICATIONS

The instant application claims priority to International Patent Application No. PCT/GR2023/000016, filed May 2, 2023, and to Greek Patent Application No. GR20220100540, filed Jul. 7, 2022, each of which is incorporated herein in its entirety by reference.

### FIELD OF THE DISCLOSURE

The present disclosure generally relates to electronic communication between electronic systems and, more particularly, to electronic communication concerning vehicle registration systems.

### BACKGROUND OF THE INVENTION

The issuance of a new license registration for a road vehicle as a result of a change of color of the vehicle, and the subsequent communication to inform police authorities and insurance companies, is a time-consuming and costly process.

Today, the process for declaring a color change varies from country to country, however, in general the process is similar, as for public interest and safety reasons, once the color change has been made, the vehicle owner has to declare the color change to the competent authorities or bodies (such as competent ministries, and/or police, and/or insurance company, etc.). This process usually takes a considerable amount of time, for example between 5 and 10 days, during which time there is uncertainty and a lack of synchronization in terms of informing the authorities and updating the data in the databases, making the circulation of the vehicle generally problematic. The vehicle circulates with a provisional registration, which is issued when the required documents are submitted and which is replaced by a new license registration several days later, when the process of issuing a new registration is completed.

Some car manufacturers have created new technologies for instant color change in a few seconds through special coatings and have presented prototype models at international car shows. These include, for example, car coatings which contain particles which, by passing an electric current through them, change the color of the car in seconds. According to a statement from BMW car manufacturer, “the surface coating of the BMW iX Flow model with “E Ink” coating contains several million microcapsules with a diameter equal to the thickness of a human hair.” Each of these microcapsules contains negatively charged white pigments and positively charged black pigments. Depending on the selected setting, stimulation by an electric field causes either the white or black pigments to collect on the surface of the microcapsule, giving the car body the desired color.

Achieving this effect on the vehicle body involves the application of several precisely positioned ePaper segments. Productive design processes are applied to ensure that the parts reflect the characteristic contours of the vehicle and the resulting variations in light and shadow. Design generation algorithms allow for the formatting and flexibility needed to tailor the ePaper precisely to the vehicle design lines.

Laser cutting technologies guarantee high precision in the creation of each part. After the parts are applied and the power supply is connected to stimulate the electric field, the entire body is heated and sealed to guarantee optimal and uniform color reproduction during each color change.

Essentially then, electricity is used to manipulate the microcapsules and change colors. Based on the color change, the technical effect achieved is to maintain the temperature inside the vehicle. For example, a combination of white colors will keep the vehicle cool in the summer, while changing the color to black will keep it warmer in the winter.

Similar technology has been developed by the AUDI car manufacturer, based on the properties of liquid crystals. As reported in relevant publications (e.g. https://indianexpress.com/article/trending/trending-globally/as-bmw-introduces-a-car-that-changes-colour-netizens-say-too-bad-for-the-cops-7711442/), this presentation is made for the sole purpose of demonstrating new technologies. This technology cannot be applied to the production models available to consumers, as the application of these technologies poses a risk to public safety. In particular, in the event of the need to identify and recognize the vehicle (e.g. if the vehicle is involved in an illegal act or an accident, etc.), it will be impossible to identify the vehicle due to an immediate change in the color of the vehicle if the immediate change has either not been deliberately reported to the authorities by the vehicle owner or has been reported but not yet registered with the competent authorities due to a delay in updating the public administration's records.

The same administrative procedure applies to the technique called “Car Wrapping”, i.e. the process whereby the entire surface of the vehicle is covered (coated) with a color change film, which is applied directly over the original color of the car, a technique that takes less time and costs less than color change by painting. Therefore, the same delay in updating public administration records occurs in the “Car Wrapping” technique.

Thus, the main technical problem currently encountered in the color change process is the time required to complete the process, i.e. the color change, the notification of the authorities on behalf of the user, the submission of the supporting documents, the issuing of a temporary license registration, the checking of the documents, the issuing of the new license registration, etc. Furthermore, the process of reinsuring the vehicle is equally problematic because in most countries, a new insurance policy with the new color is required before the vehicle or means of transport can be put back on the road. In addition to this, further time is required to update the public administration's records internally regarding the color change. This process as a whole is currently so costly in time and money that it makes it difficult and time consuming to change the color of the vehicle or conveyance. In addition, the current process makes it impossible for the vehicle industry to offer the new color change technology to the consumer.

### BRIEF SUMMARY OF THE INVENTION

The technical problem solved by the systems and methods described in the present disclosure is the communication in real time and at zero cost between the owner/user of the vehicle and the competent ministry of transport, the police and the insurance company in order to allow the automatic change of the vehicle's color immediately. The updating of the relevant databases and ensuring the correctness of the data entry is carried out in real time, resulting in the real-time issuance of the necessary new license registration. In this way, energy savings are also facilitated and accelerated depending on the prevailing climatic conditions, since by updating the data in real time, the absorption or reflection of solar rays by the vehicle and consequently the heating or air conditioning needs are directly and specifically influenced.

In one aspect, the present disclosure describes systems and methods by which the owner/user of a vehicle and/or other means of transport (automobile, motorcycles, recreational craft, aircraft, etc.), using a unique security code that accompanies the vehicle and is delivered to the buyer at the time of purchase, can choose, either through the application installed on his mobile phone or through the multimedia system that all the latest technology vehicles are equipped with, one of the available colors offered by the manufacturer for the specific model. By creating a unique pairing between the vehicle owner's smart device and the vehicle's multimedia system, and once the user has selected the desired color, communication is established through the platform of the invention and the databases with certain selected entities, such as the competent administrative authorities (for example the competent ministry of transport, the police, etc.) or private entities (for example the roadside assistance company, the insurance company, etc.). Once the above-mentioned databases have been successfully updated, the new vehicle license registration with the new color is issued by the relevant competent authority and sent electronically in real time, first to the competent administrative authorities and then to the smart device application and/or the vehicle's multimedia system. Once the new license registration is received, then and only then is the corresponding command given to the vehicle's multimedia system to change the color immediately, without the need to issue a temporary license registration.

### BRIEF DESCRIPTION OF THE SEVERAL VIEWS OF THE DRAWING(S)

FIG. 1 illustrates the topology of a system in accordance with the disclosure.

FIGS. 2a-2e illustrate a flowchart for a method in accordance with the disclosure.

### DETAILED DESCRIPTION OF THE INVENTION

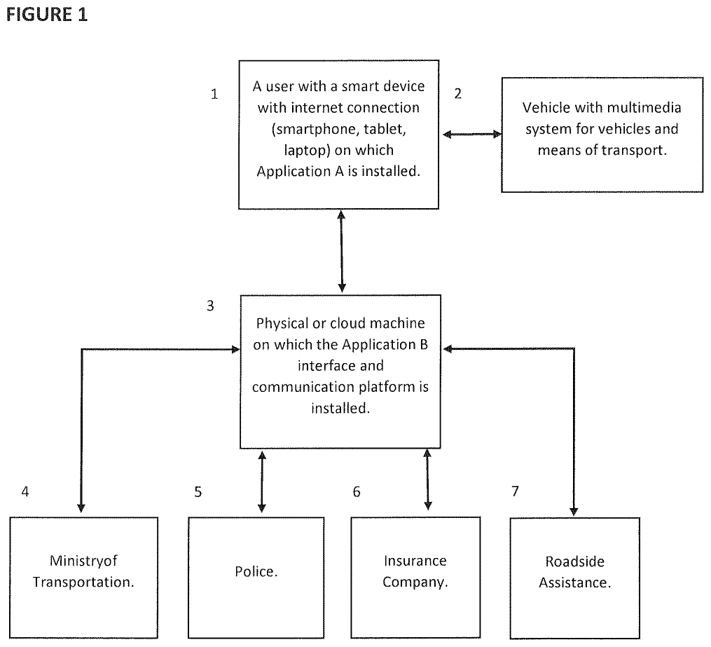

As illustrated in FIG. 1 of the system topology, the invention includes two applications, A and B.

The first one is the mobile application A (1), which is operated by the owners/users of the vehicles/transport vehicles and is installed and executed on smart devices with wireless internet connectivity, such as mobile phones, tablets, laptops, smart phones, etc. It is connected to the multimedia system of the vehicle/transport (2).

The second, Application B (3) interface and communication platform, is installed on a central server, either on a physical machine or in the cloud. Application B (3) handles the communication and connects, with Application A (1) mobile device (mobile application) and with the competent authorities (4, 5, 6, 7) which are public and/or private authorities involved in the process, such as the Ministry of Transport or other competent authority, the police and the insurance company where the vehicle/mean of transport is insured, etc.

The user operates and has direct access to Application A (1) of his smart device and to the multimedia system (2) of the vehicle but does not have direct access to Application B (3), but only indirectly, through Application A (1), as described in detail below.

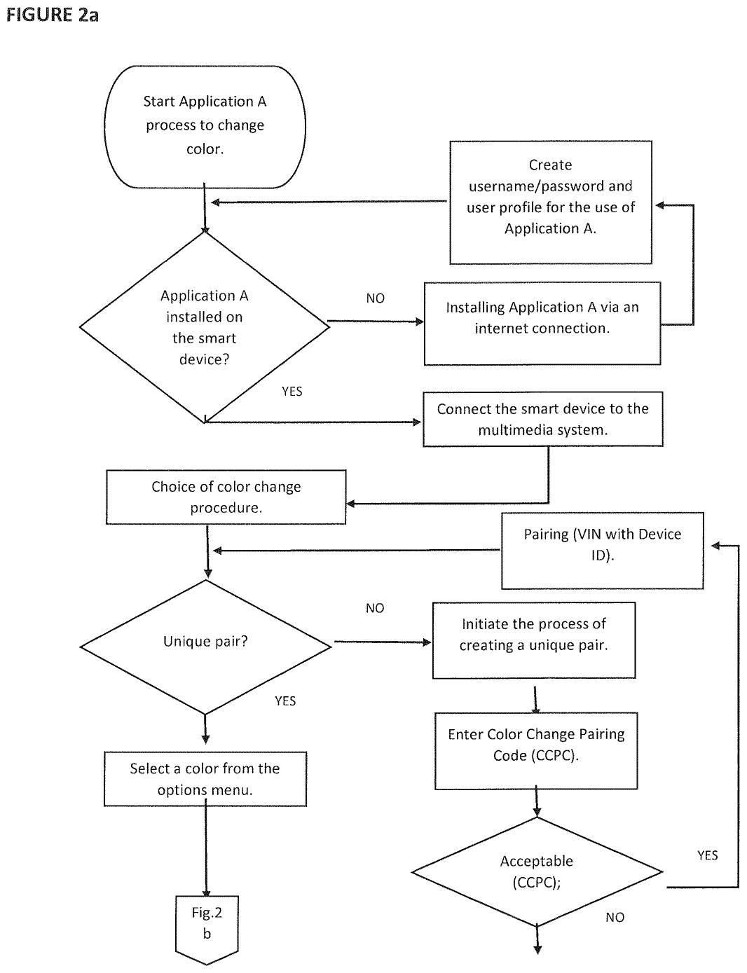

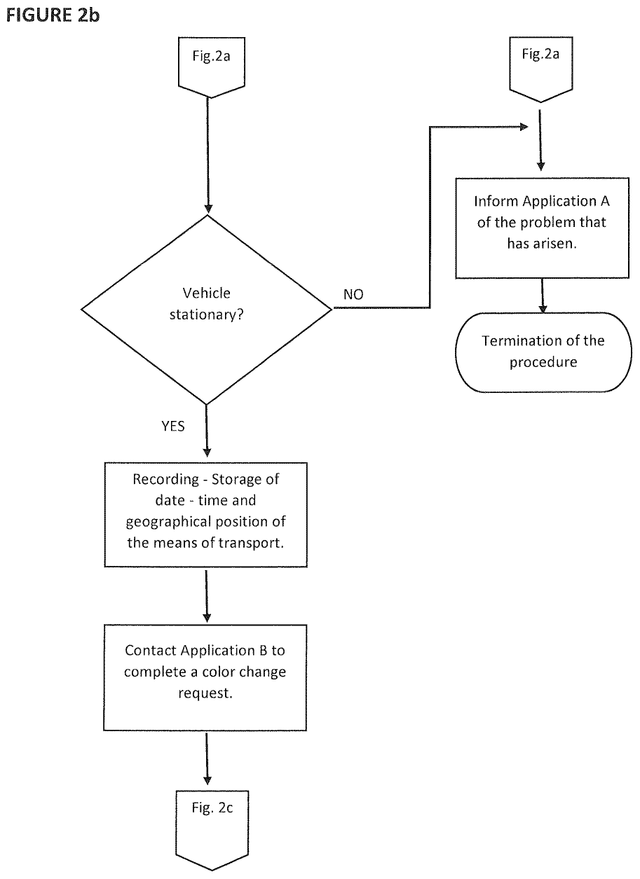

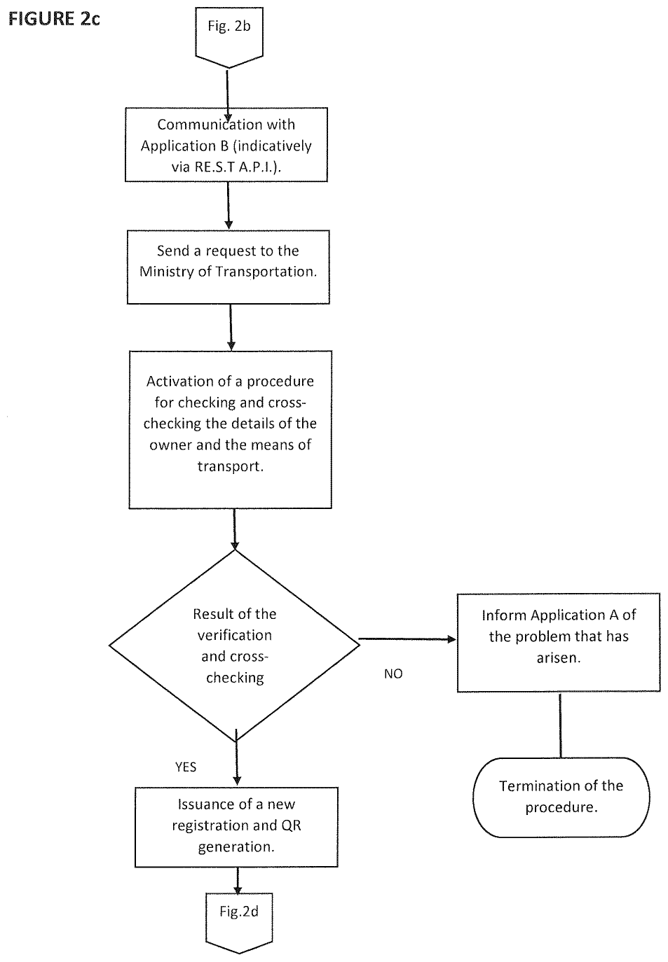

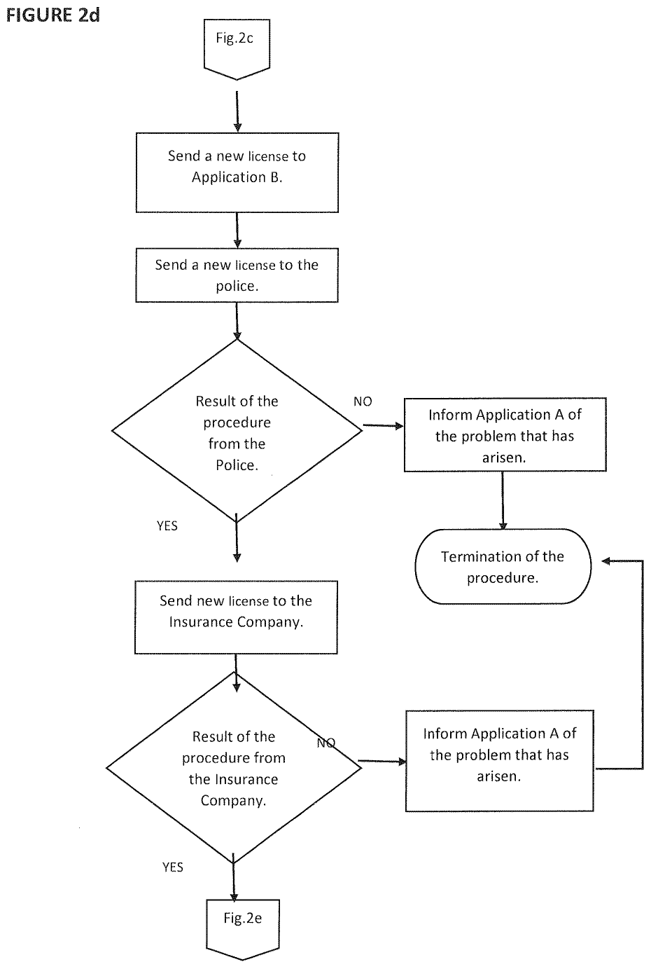

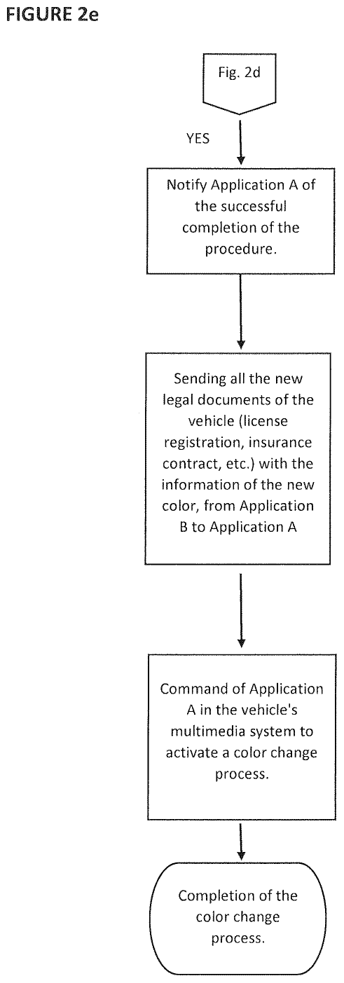

More specifically, the method of updating vehicle color change data, in real time, includes the following steps, which are illustrated in Drawing 2, which for practical purposes spans 5 pages as FIG. 2a, FIG. 2b, FIG. 2c, FIG. 2d and FIG. 2e.

### Step 1: Installing Application a on the User's Smart Device

As illustrated in FIG. 2a, the installation of the first application, Mobile Application A, is done by the system user on his mobile phone or any smart device. The application is implemented on mobile devices with any operating system, including but not limited to IOS and ANDROID, etc. To complete the installation, the user is asked to create the personal user profile by entering various personal data, such as but not limited to the first name, last name, ID number and license plate number of his vehicle/means of transport, along with a user code (Username) and security code (Password) of his choice. Subsequently, the two-factor authentication mechanism is adopted and the system asks the user to enter biometric characteristics, such as, but not limited to, fingerprint or face id check, etc.

The profile creation process with Username and Password and biometric features protects the user from any malicious or non-malicious use of the color change application by a third party without his permission and ensures public safety and the smooth operation of the public administration.

The second application, Application B (3) interface and communication platform, is installed on a central server, either on a physical machine or in the cloud.

### Step 2: Connecting the User's Smart Device to the Vehicle's Multimedia System According to the State of the Art

The smart device (1) is then connected to the multimedia system (2) of the vehicle/means of transport, wirelessly via Bluetooth or WiFi or wired via a cable to a USB port, as in the present state of the art. The multimedia system (2) is the main computer of the vehicle, manages all the information concerning the vehicle, such as the Vehicle Identification Number (VIN number, the unique number assigned to the vehicle by its manufacturer at the time of its manufacture), the operation of the radio, air conditioning, GPS, etc., and is responsible for the transfer of data to the individual systems connected to it. The connection shall be made by any of the methods provided for in the current state of the art.

### Step 3: Activation of the Color Change Menu and Introduction of the Color Change Pairing Code (CCPC)—Recording of the Vin Number in the Smart Device

After connecting the smart device (1) to the multimedia system (2) of the vehicle/means of transport, the user can use all the functions of the Color Change Application, such as, but not limited to, statistics on fuel and electricity consumption, refueling points, geographical characteristics and vehicle route, etc., as well as the vehicle color change. In particular, for changing the color for the first time, the user selects the color change function and activates it using a special unique Color Change Pairing Code (CCPC), which according to the invention is factory set (by the manufacturer) and is given to the owner upon purchase of the vehicle. This is a code for pairing to the multimedia system and is only relevant to the color change function, which code, in the example embodiment of the inventive concept described here, can be an eight-digit alphanumeric code and which must never be kept inside the vehicle by the owner (so that there is no possibility of it coming into the possession of a third party, non-owner). In this way a pair is established between the user's smart device (1) and the vehicle's multimedia system (2). This process is only relevant for the first time the user changes the color of the vehicle. For subsequent color changes, with the same smart device (1) and the same vehicle, no pairing is required, because the vehicle's multimedia system has recorded the ID number of the device (1) from the first time. Since several multi-user devices can be connected to the vehicle's multimedia system, the color change process can only be performed by the owner/user device (1) that will have made the pairing with the Color Change Pairing Code (CCPC), which is exclusively related to the color change.

With the pairing, synchronization is achieved between the multimedia system (2) and Application A installed on the smart device (1). Application A installed on the smart device (1) records the VIN number of the vehicle which is unique for the vehicle, and at the same time the vehicle's multimedia system (2) records the ID number of the smart device (1).

With the above steps, the multimedia system (2) is connected to the smart device (1) of the user/owner and through it to Application A.

Steps 1 to 3 above are done once during the initial installation of Application A and the creation of the color change link and are not repeated.

In case of resale of the vehicle, the new owner is given, according to the invention, the unique Color Change Pairing Code (CCPC) because with this code the new owner will make a new pairing with his own smart device (1). Alternatively, the system is reset to factory settings and the new owner will have to go to the official dealership and ask for a new unique Color Change Pairing Code (CCPC) to be issued.

In case of theft of the vehicle, a color change cannot be achieved by the offender, because the use of the unique Color Change Pairing Code (CCPC) will be required.

In case the user changes his smart device (1), he will have to re-install the application on his new device (1) and then connect the new device (new pairing) to the multimedia system (2), according to Step 2, using the same Color Change Pairing Code (CCPC).

In case of theft of the smart device (1), there is no public order risk, since the biometric characteristics of the owner are necessary for the smart device to execute the color change command.

### Step 4: Initiation of the Vehicle Color Change Process

Then, after the successful completion of the pairing process (in Step 3) and the synchronization between the media system (2) and Application A, the user can make the first color change.

The color change may be performed either by the smart device (1) Application A or by the media system (2) by entering a code requested by the media system and reproduced by the smart device (1). This code is, according to the current state of the art, a rolling code valid for a predetermined period of time (e.g. 60 seconds), in order to ensure that there is no accumulation of codes for post-dated uses. Then, from the color change menu, the vehicle/transportation means owner selects the color he wishes from a palette of available colors or designs and finalizes his choice without the possibility of withdrawal.

### Step 5: Transmission of Color Change Request

With the vehicle immobilized (for example, in the case of a car, it must be stationary, with the gear selector in the ‘park (P)’ or ‘neutral’ position and the handbrake on, and in the case of other vehicles, with the corresponding immobilizing devices engaged, etc.) (drawing 2b), as soon as the user selects the color and presses the confirmation button (Step 4), the Application A installed on the smart device (1) (mobile application) records for security reasons the date, all data such as time and position of the vehicle with latitude and longitude and at the same time automatically connects via internet in real time with continuous and uninterrupted communication (indicative technology RE.S.TA.P.I—Representational State Transfer Application Programming Interface) with the Application B interface and communication platform and transfers the specific color selection and all the above data as a first set of data to the competent authorities for approval (FIG. 2c).

### Step 6: Informing Public Authorities of the Change of Color—Legalization Check of the User

The Application B (3) interface and communication platform is connected in the same way in real time (indicatively by technology via RE.S.TA.P.I.) with the main computer and the database of the Ministry of Transport or the competent authority in accordance with the applicable legislation. There it informs about the imminent change of a specific color of the vehicle/means of transport with the chassis number and license plate number as successfully recorded in the above steps.

The competent authority's computer, using technology that ensures the security and uniqueness of the interface between Application B and the authority (indicatively, HASP processor technology), performs a user authentication check, i.e. a check of the cross-check of the data of the owner and the vehicle for which the color change is requested. This is followed by a check and matching of the vehicle identification number (VIN) with the license registration and a check of additional parameters concerning the existence of all legal requirements and the absence of legal irregularities on the part of the user, such as, but not limited to, that no license registration fees are due, that the driver's license is valid, etc. The result of this check is the identification of the specific user as the legal owner of the specific vehicle, or as the legal representative of the legal owner. The particular data information of the legalization is described above as an example embodiment of the present invention. The legalization applies accordingly to cases of other vehicles, implementing the invention in a similar way. In case the vehicle/mean of transport is moved or if a problem or irregularity is detected in any of the above checks, the process is immediately stopped, and the user/owner is informed that his request for a color change is rejected (FIG. 2c).

### Step 7: Completion of Legalisation Check—Issue of New License Registration

Once the user's legalization check has been successfully completed, the change of color is approved by the Ministry of Transport or the competent national authority and the new license registration with the new color is automatically issued. At the same time a “QR Code” (Quick Response, a two-dimensional bar code) containing the details of the new license registration is generated, thus creating a second set of data (FIG. 2c).

### Step 8: Transmission of the New License Registration to the Competent Authorities

The QR Code containing the new license registration is sent from the central computer of the Ministry of Transport or the competent national authority that issued the license registration, back to the Application B (3) interface and communication platform, which simultaneously connects in the same way (indicatively with technology via RE.S.TA.P.I) with the databases of further involved authorities, such as, indicatively, the police and the insurance company and informs them about the new license registration that has just been issued (FIG. 2d).

Immediately after the successful update of the databases of the entities involved (indicatively, the police and the insurance company), the public documents (entries) are modified and adapted to the new data (such as, indicatively, the insurance company issues a new insurance contract based on the new license registration) and a third data set is created with the QR Codes issued with the new data of the vehicle documents.

### Step 9: Transmission of the New License Registration to the User/Owner

At the same time, the Application B (3) interface and communication platform reconnects to the Application A of the smart device (mobile application) and sends the QR Code with the new license registration and the QR Code with the new insurance contract to the Application A of the user/owner's smart device. When the license registration is received by application A, the process is completed and then and only then a command is given by application A to the vehicle's multimedia system and the change of the selected color is executed (FIG. 2e).

In case the applicable legislation provides for additional legal documents, these are communicated in the same way, i.e. by issuing a new QR Code (re-encoding of data) that is sent to the smart device (1) of the user/owner.

Both the QR Code with the license registration and the QR Code with the new insurance contract (or any other legal documents provided for by the applicable legislation, such as, for example, driving license and identity card) remain in Application A on the user's/owner's smart device to be shown in case of inspection by the authorities. At the same time, they are also saved in the multimedia system of the vehicle/means of transport so that in case of damage or loss of the smart device on which the App A is installed, they can be scanned and the necessary inspection can be carried out from there. In addition, the App A on the smart device provides a printing function via a wireless connection to a printer of the owner's choice in case the owner wishes to print the new license registration and/or the new insurance contract.

The color change process as described above can take from a few seconds to a few minutes depending on the available network in the area where the user/owner of the vehicle is located at the time. The mechanism is fully automated so that it can operate twenty-four hours a day, seven days a week quickly, timely and in complete safety. Without an available network, the method cannot be implemented.

In an example embodiment of the inventive method, further involved entities according to Step 8, include any public and/or private entity responsible for any color change, according to the national legislation governing the vehicle.

In a further example embodiment of the inventive method, the third set of data according to Step 8, includes the insurance policy, the contract with the roadside assistance company and any legal document provided by the respective applicable legislation of the state of the vehicle in case of a color change.

In a further example embodiment of the inventive method, the further involved parties included in the set of further involved parties belong to more than one state.

In a further example embodiment of the inventive method, Application A, through its connection to the vehicle's multimedia system, records and displays any of the following information about the vehicle: exterior temperature, interior temperature, engine temperature, fuel level, tire air pressure, tire air pressure, engine oil level, battery and/or battery charge level, nearest fueling point or electric car battery charging station, all color changes that have taken place, statistics on distances and cities visited by the vehicle by color, region, days of the week, hours of the day.

In a further example embodiment of the inventive method, if the applicable legislation provides for additional legal documents, these are communicated by re-encoding data sent encoded to the user/owner's smart device (1) according to step 9.

Both Application A on the smart device (mobile application) and Application B (3) interface and communication platform can be configured and operate based on the specifications of the manufacturer and/or the legislator, with the criterion of protecting public order. For example, color change will be able to occur at specified intervals e.g., only once (1) per week or based on number of changes per year e.g., up to twenty (20) times per year and/or in combination.

Additional features and functions of the Application A (mobile application): By using the application, the owner is informed of all the color changes he has made in the form of a list and a sophisticated visualization on the map. He sees statistics on the kilometers and cities he has visited by color, region, days in the week, hours in the day, etc. The application, through its connection to the multimedia system of the vehicle, can also display the following vehicle information: external temperature, internal temperature, engine temperature, petrol level, tire pressure, air pressure, engine oil level, battery and/or battery level, nearest refueling point (fuel or electric car battery charging station).

Additional features and functions of the Application B interface and communication platform: The platform stores the information of VIN, vehicle registration number and geographic location of the car when changing the color and is available to competent authorities whenever necessary. In addition, the application easily and quickly processes a multitude of information and automatically generates statistics and reports useful for the parties involved, such as transport ministries, insurance companies, police authorities, etc.

The invention is applicable to all automotive industries that have developed new technologies that achieve color change instantaneously, within a few seconds, through special coatings containing particles which, by means of electricity or other technology, change the color of the car in seconds, as well as to industries producing other vehicles and means of transport where a registration permit is required due to color change. These are industries producing cars, motorcycles, buses, buses, yachts, aircraft, trains, trains and other vehicles, means of transport and means of public transport.

Furthermore, the invention is applicable to all public and private bodies and/or organizations involved in the correct and safe operation and/or circulation of vehicles, means of transport, public transport, etc. It contributes to fast and secure communication between them for the control and processing of information data in order to ensure smooth traffic flow and protect public safety. These entities in the example embodiment of the invention described herein are the competent ministries of transport and traffic together with their branches, police authorities, roadside assistance companies and insurance companies.

The invention may additionally find application for the real-time updating of other vehicle data and vehicle characteristics mentioned in the vehicle registration. For example:
the case of a change in the weight of the vehicle resulting from the replacement of batteries
the case of a change in the dimensions of the vehicle resulting from the automatic lengthening of parts of the vehicle (a technique that has been shown experimentally), etc.
where it is necessary to inform the authorities and all parties involved, in the same way as for a color change.

Furthermore, the invention also applies to special purpose vehicles, such as military vehicles (e.g., camouflage color change) where the recording and updating of data takes place in real time by specialized operators and in special purpose files.

Also, in the case where transnational cooperation is required, as is the case for example in changing the country of classification, the invention can be applied in a similar way.

The invention of updating vehicle color change data in real time, has the advantage of achieving real-time updating of the administration data. Moreover, the sequence of actions is changed with respect to the current state of the art, so as to enable the implementation of the new technology presented by the automotive industry: the color change is no longer preceded, as is the case today, but is only carried out after the administration has been informed and a new final registration license has been issued directly. This offers the advantage of protecting public safety, while at the same time minimizing the immobilization of the car, compared to the long time currently required for the approval of the color change. In addition, the invention solves the problem of communication with the relevant competent administrative authorities (Ministry of Transport, and/or police, and/or insurance company, etc.) and avoids bureaucratic errors, because human intervention is minimized. The information is automatically updated in real time without any additional costs and charges. Moreover, the color change process can be carried out at any time or day without any restrictions due to the opening hours of the competent authorities and parties. Furthermore, the cost of paper and other accompanying forms is significantly reduced as the invention is a green solution. Studies show that consumers would regularly change the color of their vehicle if they had the opportunity to do so in order to satisfy the need for change in their daily lives and the feeling of being ‘new’. Finally, because the new technologies that make it possible to change color in seconds eliminate paints that are environmentally unfriendly materials, the implementation of the present invention will result in a reduction in harmful paints, toxic materials, and transportation and energy costs because the materials are much lighter and significantly reduce the weight of the vehicles.

The invention is identified by the claims. Wherever the term “vehicle” is used in the Description and the Claims, it includes any means of transport capable of changing color. Wherever the term “color change” is mentioned in the Description and Claims, it also means a change to a non-single color, but to colors containing patterns or different shades, etc.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for updating vehicle color change data in real time for a vehicle, comprising:
installing a first application A on a smart device connected to a user, and installing on a server computer an interface and communication platform B,
connecting the smart device to a multimedia system of the vehicle, and pairing the smart device with the vehicle;
activating a color change function of the multimedia system of the vehicle using a unique factory Color Change Pairing Code associated with the vehicle using the first application A, wherein activating the color change function includes recording a unique vehicle identification number in Application A of the smart device, and recording the unique identification code of the smart device in the multimedia system;
initiating the color change function, the color change function comprising selecting a color for the vehicle in the multimedia system;
confirming the color selection and recording via Application A the color selected, the date, time, geographical position, latitude and longitude of the vehicle and other vehicle data; and transmitting a color change request including the color selected, the date, time, geographical position, latitude and longitude of the vehicle and other vehicle data in real time to a central server associated with competent authorities for approval via the an interface and communication platform B;
informing the competent authority of the impending change of the vehicle and seeking approval of the color change request via the interface and communication platform B;
receiving approval of the color change request, receiving a new registration permit for the vehicle with the selected color via the interface and communication platform B;
commanding from application A to the vehicle's multimedia system to change the selected color, and changing of color of the vehicle in real time.

2. The method of claim 1, wherein the user is identified by the first application A with a two-factor authentication function.

3. The method of claim 1, wherein the server computer resides either on a physical machine or in the cloud.

4. The method of claim 1, wherein activating the color change function is performed during an initial setup procedure and is not repeated.

5. The method of claim 1, wherein selecting the color is accomplished by selection from a list of available colors by the smart Device Application A or by the Multimedia System, by entering a code requested by the Multimedia System and generated by the Smart Device, and finalizing the color selection without possibility of withdrawal.

6. The method of claim 1, wherein the competent authority evaluates the color change request to the selected color, wherein the competent authority performs user legalization checks that include checking and matching the vehicle identification number with the license registration and checking additional parameters concerning the absence of legal irregularities on the user, identifies the user as a legal owner of the vehicle, and approves the color change request when all information is valid.

7. A system for updating vehicle color change data in real time, comprising:
providing a first application A for installation on a smart device connected to a user, and installing on a server computer an interface and communication platform B;
providing a multimedia system of the vehicle that is connectable to the smart device, and pairing the smart device with the vehicle;
wherein the smart device and the multimedia system are configured to:
activate a color change function of the multimedia system of the vehicle using a unique factory Color Change Pairing Code associated with the vehicle using the first application A, wherein activating the color change function includes recording a unique vehicle identification number in Application A of the smart device, and recording the unique identification code of the smart device in the multimedia system;
initiating the color change function, the color change function comprising selecting a color for the vehicle in the multimedia system;
confirming the color selection and recording via Application A the color selected, the date, time, geographical position, latitude and longitude of the vehicle and other vehicle data; and transmitting a color change request including the color selected, the date, time, geographical position, latitude and longitude of the vehicle and other vehicle data in real time to a central server associated with competent authorities for approval via the an interface and communication platform B;
informing the competent authority of the impending change of the vehicle and seeking approval of the color change request via the interface and communication platform B;
receiving approval of the color change request, receiving a new registration permit for the vehicle with the selected color via the interface and communication platform B;
commanding from application A to the vehicle's multimedia system to change the selected color, and changing of color of the vehicle in real time.

8. The system of claim 7, wherein the user is identified by the first application A with a two-factor authentication function.

9. The system of claim 7, wherein the server computer resides either on a physical machine or in the cloud.

10. The system of claim 7, wherein activating the color change function is performed during an initial setup procedure and is not repeated.

11. The system of claim 7, wherein selecting the color is accomplished by selection from a list of available colors by the smart Device Application A or by the Multimedia System, by entering a code requested by the Multimedia System and generated by the Smart Device, and finalizing the color selection without possibility of withdrawal.

12. The system of claim 7, wherein the competent authority evaluates the color change request to the selected color, wherein the competent authority performs user legalization checks that include checking and matching the vehicle identification number with the license registration and checking additional parameters concerning the absence of legal irregularities on the user, identifies the user as a legal owner of the vehicle, and approves the color change request when all information is valid.
